(19) United States
(12) Patent Application Publication
(10) Pub. No.: US 2013/0094619 A1
(43) Pub. Date: Apr. 18, 2013

(54) SYSTEMS AND METHODS FOR PACKET DETECTION

(71) Applicant: QUALCOMM Incorporated, San Diego, CA (US)

(72) Inventors: Stephen J. Shellhammer, Ramona, CA (US); Sameer Vermani, San Diego, CA (US); Rahul Tandra, San Diego, CA (US)

(73) Assignee: QUALCOMM Incorporated, San Diego, CA (US)

(21) Appl. No.: 13/653,124

(22) Filed: Oct. 16, 2012

Related U.S. Application Data
(60) Provisional application No. 61/548,125, filed on Oct. 17, 2011.

(51) Int. Cl. H04B 1/06

(52) U.S. Cl. 375/343

(57) ABSTRACT

Systems, methods, and devices for detecting packets in signals are described herein. The apparatus comprises a receiver configured to receive a signal comprising a plurality of samples. The apparatus comprises circuitry. The circuitry is configured to apply a match filter to the plurality of samples to produce a plurality of blocks of samples, each block comprising a number of samples. The circuitry is configured to correlate a subset of the samples of a first block with a subset of the samples of a second block to produce an output. The circuitry is configured to compare the output to a threshold value to determine whether the signal comprises a data packet.

### CROSS-REFERENCE TO RELATED APPLICATIONS

The disclosure claims priority to U.S. Provisional Patent Application No. 61/548,125 filed Oct. 17, 2011, entitled “SYSTEMS AND METHODS FOR PACKET DETECTION,” which is assigned to the assignee hereof The disclosure of the prior application is considered part of, and is incorporated by reference in, this disclosure.

### TECHNICAL FIELD

The present application relates generally to wireless communications, and more specifically to systems, methods, and devices for packet detection.

### DESCRIPTION OF THE RELATED TECHNOLOGY

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information as signals between each other. For example, a first device may transmit data packets to a second device. The second device may receive those data packets as a signal. The second device may further receive other signals that may not be intended for the second devices, causing interference. The second device, therefore, may need to determine whether a signal received is a data packet or not in order to properly process the signal. Accordingly, systems and methods for packet detection are needed.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include packet detection in wireless communication systems.

One aspect of the disclosure provides an apparatus for wireless communication. The apparatus comprises a receiver configured to receive a signal. The apparatus further includes circuitry configured to generate a plurality of samples from the signal. The circuitry may be further configured to apply a match filter to the plurality of samples to produce at least a first block of samples and a second block of samples, each block comprising a number of samples, correlate at least a portion of the samples of the first block and the samples of the second block to produce a correlation output; and compare the output to a threshold value to determine whether the signal comprises a data packet. In some implementations, the received signal comprises a sequence of training fields. The match filter may be configured such that a response of the match filter is a function of a complex conjugate of a time reversal of a training field. The threshold value can be determined based on a power level of the received signal. In some implementations, the circuitry is further configured to correlate a subset of the samples of a first block with a subset of the samples of a second block to produce the correlation output. The circuitry may further configured to correlate a subset of the samples of each block of the plurality of blocks with a subset of the samples of a subsequent block of the plurality of blocks to produce a plurality of outputs, and produce the correlation output from the plurality of outputs. In some implementations, the circuitry is further configured to sum the plurality of outputs to produce a sum, and calculate an absolute value of the sum to produce the correlation output. In some implementations, the circuitry is further configured to apply a plurality of match filters to a plurality of copies of the plurality of samples to produce a plurality of different sets of the plurality of blocks of samples, correlate, for each set of the plurality of blocks, a subset of the samples of each block of the plurality of blocks with a subset of the samples of a subsequent block of the plurality of blocks to produce a plurality of outputs, and compare each of the plurality of outputs to a threshold value to determine whether the signal comprises a data packet. The correlation output may be an autocorrelation result.

In another innovation, a method for wireless communication includes receiving a signal comprising a plurality of samples, applying a match filter to the plurality of samples to produce a plurality of blocks of samples, each block comprising a number of samples, correlating a subset of the samples of a first block with a subset of the samples of a second block to produce an output, and comparing the output to a threshold value to determine whether the signal comprises a data packet.

Another aspect of the disclosure includes an apparatus for wireless communication, the apparatus including means for receiving a signal comprising a plurality of samples, means for filtering the plurality of samples to produce a plurality of blocks of output samples, each block comprising a number of match filter output samples, means for correlating a subset of the samples of a first block with a subset of the samples of a second block to produce an output, and means for comparing the output to a threshold value to determine whether the signal comprises a data packet. In some implementations, the signal receiving means comprises a receiver. In some of the implementations, the filtering means comprises a matched filter. In some of the implementations, the correlating means comprises a correlation circuit. In some implementations, the comparing means comprises a processor.

Another aspect of the disclosure includes a receiver configured to receive a signal comprising a plurality of samples, and circuitry configured to apply a match filter to the plurality of samples to produce a plurality of blocks of match filter output samples, each block comprising a number of match filter output samples, generate at least one autocorrelation result from the plurality of blocks of the match filter output samples, and compare the autocorrelation result to a threshold value to determine whether the signal comprises a data packet.

Another aspect of the disclosure includes a computer readable medium comprising instructions that when executed cause an apparatus to receive a signal comprising a plurality of samples, apply a match filter to the plurality of samples to produce a plurality of blocks of samples, each block comprising a number of samples, correlate a subset of the samples of a first block with a subset of the samples of a second block to produce an output, and compare the output to a threshold value to determine whether the signal comprises a data packet.

### BRIEF DESCRIPTION OF THE DRAWINGS

FIG. 1 is a schematic illustrating an example of a wireless communication system in which aspects of the present disclosure may be employed.

FIG. 2 is a block diagram illustrating various components, including a receiver, that may be utilized in a wireless device that may be employed within the wireless communication system of FIG. 1.

FIG. 3 is a schematic illustrating an example of a time-domain representation of a sequence of training fields.

FIG. 4 is a schematic illustrating an example output y(n) of the match filter of FIG. 2 based on the input signal r(n) comprising the sequence of training fields of FIG. 3.

FIG. 5 is a block diagram illustrating an example of a signal detector that may be the signal detector shown in FIG. 2.

FIG. 6A is a flow diagram illustrating an example packet detection procedure for detecting packets in a signal r(n).

FIG. 6B is another flow diagram illustrating an example packet detection procedure for detecting packets.

FIG. 7 is a flow diagram illustrating another example packet detection procedure for detecting packets in a signal r(n).

FIG. 8 is a functional block diagram of an exemplary wireless device that may be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols. For example, the various aspects described herein may be used as part of the IEEE 802.11ah protocol, which uses sub-1 GHz frequency bands.

Implementations described herein generally relate to packet detection. Devices in a wireless network may transmit/receive information as signals between each other. For example, a first device may transmit data packets to a second device. The second device may receive those data packets as a signal. The second device may further receive other signals that may not be intended for the second devices, causing interference. The second device, therefore, may need to determine whether a signal received is a data packet or not in order to properly process the signal. Accordingly, systems and methods for packet detection are needed.

In some implementations, a wireless device, such as a wireless device may receive signals transmitted from other devices, which may also be wireless devices. For example, a first wireless device may receive signals comprising data packets from a second wireless device. In some implementations, the second wireless device may transmit signals according to an IEEE 802.11 standard. According to the IEEE 802.11 standard there are several orthogonal frequency division multiplexing (OFDM) physical (PHY) layers. Accordingly, in some implementations, the signal transmitted by the second wireless device having one or more data packets begins with a sequence of training fields. The first wireless device may utilize these training fields for several purposes, including packet detection. For example, the first wireless device may have stored in memory information as to what training field(s) are used by the second wireless device when transmitting a signal comprising one or more data packets. The information regarding the training field(s) may be preprogrammed in the first wireless device at the time of manufacture, sent in a message from another device when the device is activated, or received by the first wireless device in some other manner.

The information may be updated as well. If the first wireless device determines that a received signal has a sequence of known training fields, the first wireless device may determine that a data packet is detected. In one implementation, the training fields may be referred to as short training fields (STFs). The duration of an STF may be the fraction of the duration of an OFDM symbol used for transmission by the second wireless device. For example, the STF may be ¼^{th} the duration of an OFDM symbol (excluding a cyclic prefix). In another implementation, the training fields may be longer, such as ½ the duration of an OFDM symbol (excluding a cyclic prefix). Such training fields may be referred to as medium training fields (MTFs). In another implementation, the training fields may be even longer, such as the duration of an entire OFDM symbol (excluding a cyclic prefix).

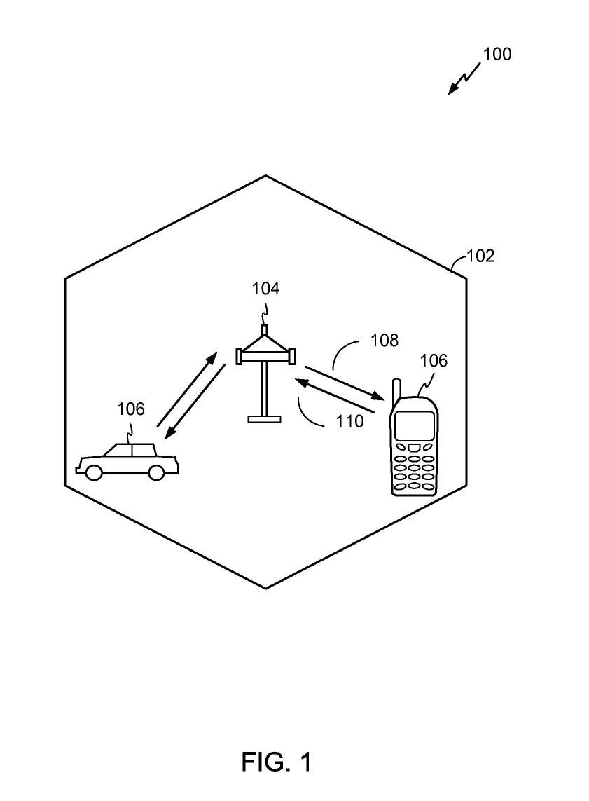

Such a first wireless device may receive the signal comprising a sequence of training fields and utilize the signal to perform packet detection as discussed in detail below. For example, the first wireless device may include a signal detector that passes the signal through a match filter to perform a cross correlation of the received signal with the known training field stored at the first wireless device. Further, the first wireless device may pass the output of the match filter to an autocorrelator to autocorrelate the output. The autocorrelated output from the autocorrelator may be compared to a threshold level to determine whether or not the signal includes a sequence of training fields, thus indicating a packet is detected as discussed below. In some implementations, the match filter may be designed to compensate for frequency offset between the first and second wireless devices. Further, in some implementations, the received signal may be processed (e.g., multiplied by an offset factor) to compensate for frequency offset as discussed below. A signal detector may be configured to perform well by detecting packets in both additive white Gaussian noise and multipath channels. Further details of such implementations are discuss below in reference to the FIGS. 1-8.

In some aspects of network technologies, wireless signals may be transmitted using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a Wi-Fi (e.g., IEEE 802.11 protocol such as 802.11ah, 802.11a, 802.11ac, etc.) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Certain of the devices described herein may implement various communication standards, for example, the 802.11ah standard. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g., for use with hotspots), or to implement machine-to-machine communications.

FIG. 1 is a schematic illustrating an example of a wireless communication system 100 in which aspects of the implementations described herein may be employed. The wireless communication system 100 may operate pursuant to a wireless standard, for example an IEEE 802.11 standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

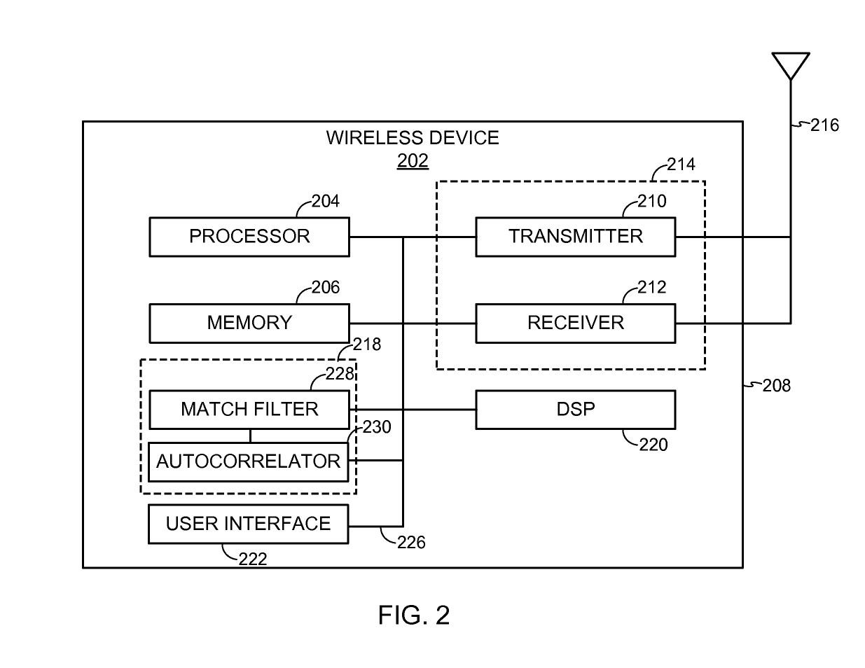

FIG. 2 is a block diagram illustrating various components, including a receiver, that may be utilized in a wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

When the wireless device 202 is implemented or used as a transmitting node, the processor 204 may be configured to generate data packets for transmission. When the wireless device 202 is implemented or used as a receiving node, the processor 204 may be configured to detect and process packets.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The transmitter 210 may be configured to wirelessly transmit packets and/or signals. For example, the transmitter 210 may be configured to transmit packets generated by the processor 204, discussed above.

The receiver 212 may be configured to wirelessly receive packets and/or signals.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals.

In some implementations, the signal detector 218 may comprise a match filter 228 and an autocorrelator 230. The match filter 228 may be used in conjunction with the autocorrelator 230 to determine whether signals received at the wireless device 202 comprise data packets, as further discussed below.

The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

For ease of reference, when the wireless device 202 is configured as a transmitting node, it is hereinafter referred to as a wireless device 202t. Similarly, when the wireless device 202 is configured as a receiving node, it is hereinafter referred to as a wireless device 202r. A device in the wireless communication system 100 may implement only functionality of a transmitting node, only functionality of a receiving node, or functionality of both a transmitting node and a receive node.

The wireless device 202r may receive signals transmitted from other devices such as the wireless device 202t. For example, the wireless device 202r may receive signals comprising data packets from the wireless device 202t.

In some implementations, the wireless device 202t may transmit signals according to an IEEE 802.11 standard. According to the IEEE 802.11 standard there are several orthogonal frequency division multiplexing (OFDM) physical (PHY) layers. Accordingly, in some implementations, the signal transmitted by the wireless device 202t comprising one or more data packets begins with a sequence of training fields. The wireless device 202r may utilize these training fields for several purposes, including packet detection. For example, the wireless device 202r may have stored in memory information as to what training field(s) are used by the wireless device 202t when transmitting a signal comprising one or more data packets. The information regarding the training field(s) may be preprogrammed in the wireless device 202r at the time of manufacture, sent in a message from another device when the device is activated, or received by the wireless device 202r in some other manner. The information may be updated as well. If the wireless device 202r determines that a received signal has a sequence of known training fields, the wireless device 202r may determine that a data packet is detected.

In one implementation, the training fields may be referred to as short training fields (STFs). The duration of an STF may be the fraction of the duration of an OFDM symbol used for transmission by the wireless device 202t. For example, the STF may be ¼^{th} the duration of an OFDM symbol (excluding a cyclic prefix). In another implementation, the training fields may be longer, such as ½ the duration of an OFDM symbol (excluding a cyclic prefix). Such training fields may be referred to as medium training fields (MTFs). In another implementation, the training fields may be even longer, such as the duration of an entire OFDM symbol (excluding a cyclic prefix). Accordingly, it is evident that the training fields may be of any suitable length.

The wireless device 202r may receive the signal comprising a sequence of training fields and utilize the signal to perform packet detection as discussed in detail below. For example, the wireless device 202r may include a signal detector 218 that passes the signal through a match filter 228 to perform a cross correlation of the received signal with the known training field stored at the wireless device 202r. Further, the wireless device 202r may pass the output of the match filter 228 to the autocorrelator 230 to autocorrelate the output. The autocorrelated output from the autocorrelator 230 may be compared to a threshold level to determine whether or not the signal includes a sequence of training fields, thus indicating a packet is detected as discussed below. In some implementations, the match filter 228 may be designed to compensate for frequency offset between the wireless device 202r and 202t. Further, in some implementations, the received signal may be processed (e.g., multiplied by an offset factor) to compensate for frequency offset as discussed below. The signal detector 218 may be configured to perform well by detecting packets in both additive white Gaussian noise (AWGN) and multipath channels.

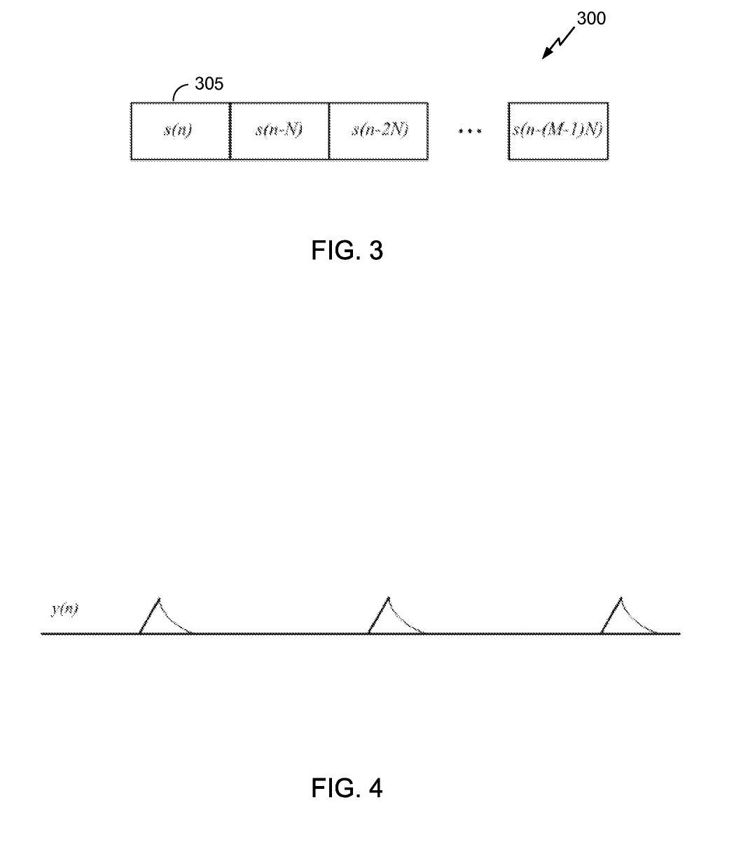

FIG. 3 is a schematic illustrating an example of a time-domain representation of a sequence of training fields 300. The sequence of training fields 300 comprises M training fields 305, where M is a positive integer. Each training field 305 comprises N samples, where N is a positive integer. In one implementation, the number of samples N depends on M and a sampling rate. In some implementations, each training field 305 includes the same N samples in the same sequence. The time-domain representation of the training field 305 may be represented by the signal s(n). The time-domain representation of the sequence of training fields 300 may be represented by the signal r(n). Accordingly, the signal r(n) comprises M time-shifted versions of the signal s(n) in sequence (s(n), s(n−N), s(n−2N), . . . , s(n−(M−1)N)). “Samples” as used herein is a broad term and generally refers to samples of the received signal. For example, there may be an analog-to-digital converter (ADC) that sample the received signal at a known sampling rate. Such samples are the periodic outputs of the ADC. In some implementations, the samples can be considered to be shifted or have an offset with respect to each other.

In one implementation, the samples for the training field 305 are selected so that the training field 305 has good autocorrelation properties. For example, one good autocorrelation property may be that the autocorrelation result (which can be referred to as simply the “autocorrelation”) of the signal comprising the training field 305 is approximately an impulse function (for example, a Dirac delta function). If the training field 305 is correlated with itself with no time offset, a resulted autocorrelation is relatively high. Further, if the training field 305 is autocorrelated with a time offset version of the training field 305, a resulted time-shifted autocorrelation becomes relatively small. It may be approximately close to 0. This may hold true even where the time offset is relatively small (e.g., 1-3 samples).

In some implementations, a longer training field (e.g., a MTF) allows for selecting samples so that the training field has better autocorrelation properties than a shorter training field (e.g., a STF). Therefore, in some implementations, longer training fields such as a MTF or a training field with the duration of an entire OFDM symbol may be used. Accordingly, a higher value of N may be used. However, it is noted that the systems and methods described herein can also be applied to shorter training fields.

As discussed above, as part of performing packet detection, the wireless device 202r may receive a signal from the wireless device 202t and perform a type of cross correlation of the received signal with the known training field 305. Convolving a signal with the complex conjugate and time reversed version of the signal is the same as autocorrelating the signal. Accordingly, since the autocorrelation of the signal s(n) is approximately an impulse function (for example, a Dirac delta function), the convolution of s(n) with its time reversed complex conjugate s(−n)* is also approximately an impulse function (for example, a Dirac delta function). Thus, the cross-correlation of the received signal with the known training field 305 may be performed using a match filter 228, where the impulse response g(n) of the matched filter is g(n)=s(−n)*.

If there is no multipath, the output of the match filter 228 for a received signal comprising the sequence of training fields 300 is a sequence of impulses every N samples. If the signal comprising the sequence of training fields 300 passes through a multipath channel before being received at the wireless device 202r, then the output y(n) of the match filter is a sequence of replicas of the multipath channel impulse response h(n) as shown in Equation 1 below.

$$y ( n ) = {\sum }_{m = 1}^{M - 1} h ( n - nN ) \qquad ( 1 )$$

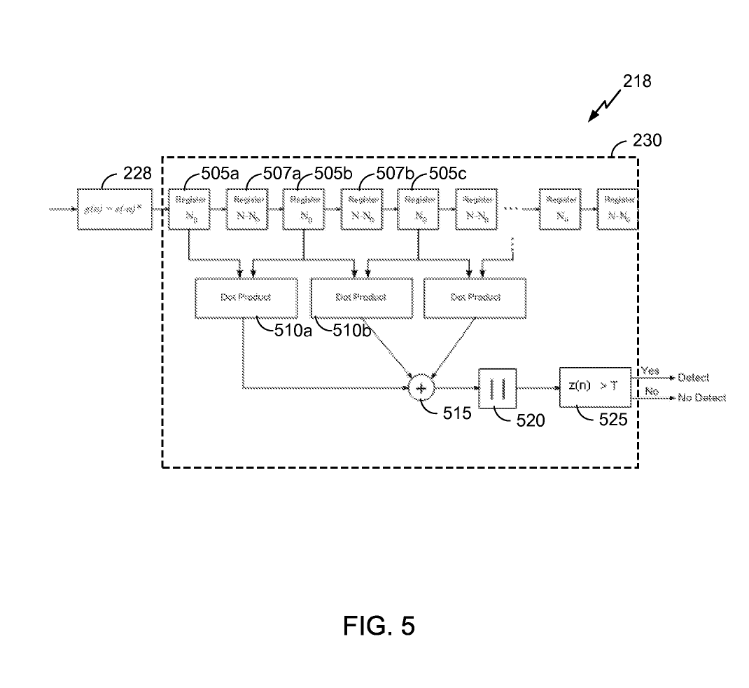

FIG. 4 is a schematic illustrating an example output y(n) of the match filter 228 of FIG. 2 based on the input signal r(n) comprising the sequence of training fields 300 of FIG. 3. In this example, the signal r(n) has passed through a multipath channel. As shown in FIG. 4, output y(n) therefore comprises a sequence of replicas of the multipath channel impulse response h(n) separated in time.

The output y(n) of the match filter 228 may then be passed to the autocorrelator 230 to perform an autocorrelation of the output y(n) and determine whether the signal includes a data packet. The signal portion of the match filter 228 output y(n) (i.e., each replica of the multipath channel impulse response h(n)) when the signal r(n) is input into the match filter 228 has a duration of N₀ samples, where N₀<N (N being the number of samples in the training field 305). Accordingly, these N₀ samples may be used in the autocorrelation summation by the autocorrelator 230 as opposed to all N samples of the output y(n). Autocorrelating the N₀ samples as opposed to all N samples may reduce the amount of noise that is captured by the signal detector 218. Further, correlating fewer samples reduces the complexity of the autocorrelation function. The value of N₀ may be selected through statistical analysis or by running simulations for a given implementation or system.

The autocorrelation summation of the N₀ samples can be implemented as follows. The first N₀ terms of the first N samples of the output y(n) are selected and correlated with the first N₀ terms of the next block of N samples (samples N+1 to 2N of y(n)). Further, each first N₀ terms of a given block of N samples is correlated with the first N₀ terms of the next block of N samples in the output y(n), until the end of the output y(n) is reached. This correlation may be represented as a dot product. The results of each dot product are then summed The absolute value of the summation is then taken and compared to a threshold to determine whether the received signal comprises a sequence of training fields 300, thus indicating detection of a packet, as discussed further below.

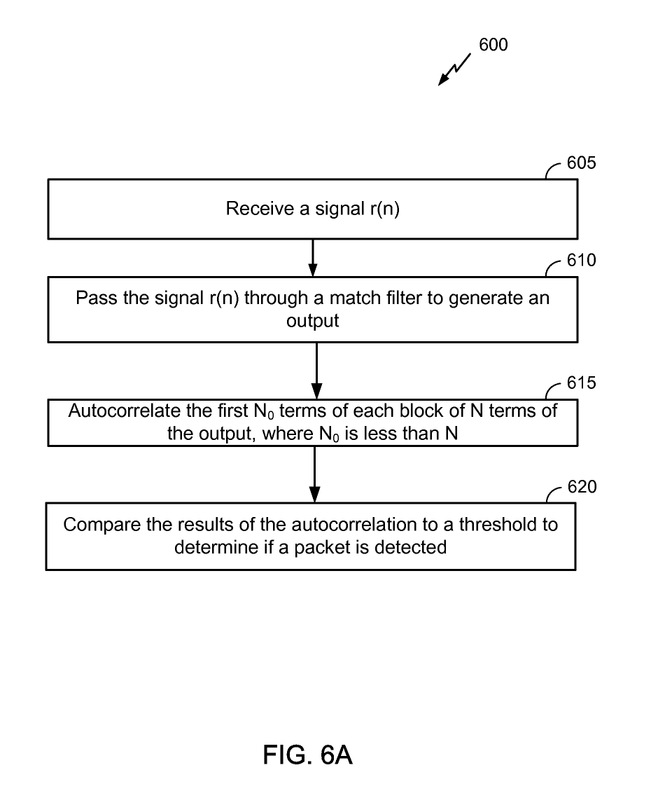

FIG. 5 is a block diagram illustrating an example of a signal detector 218 that may be the signal detector shown in FIG. 2. The signal detector 218 comprises the match filter 228 and the autocorrelator 230. The autocorrelator 230 comprises a first plurality of registers 505, a second plurality of registers 507, a plurality of dot product modules 510, a summation module 515, an absolute value module 520, and a threshold module 525. The plurality of registers 505 and 507 may be arranged as shift registers. As the output y(n) is fed into the registers 505 and 507, each register 505 may be configured to hold the first N₀ terms of a given block of N samples. Further, each register 507 may be configured to hold the N₀+1 to N terms of a given block of N samples. For example, as the first N samples are output by the match filter 228, the register 505a holds the first N₀ terms of the first N samples, and the register 507a holds the N₀+1 to N terms of the first N samples. As the second N samples are output by the match filter 228, the first N₀ terms of the first N samples are shifted to register 505b, and the N₀+1 to N terms of the first N samples are shifted to register 507b. Further, the first N₀ terms of the second N samples are stored in the register 505a, and the N₀+1 to N terms of the second N samples are stored in the register 507a. The shifting of samples through the registers 505 and 507 continues until the end of the registers is reach, whereby the N samples of the given block are discarded.

The N₀ terms in each register 505 is correlated with the N₀ terms in the subsequent register 505 by passing the input of the registers 505 into a dot product module 510. For example, the terms of register 505a and 505b are input into dot product module 510a. Further, the terms of register 505b and 505c are input into dot product module 510b. Each pair of terms is input into a different dot product module 510 to perform a correlation. Accordingly, in some implementations, there may be 1 less dot product module 510 then registers 505. Further, in some implementations, there may be an equal number of registers 507 as dot product modules 510.

The output of each of the dot product modules 510 is then input into the summation module 515 which sums all the inputs. The output of the summation module 515 is then input into the absolute value module 520, which outputs the absolute value z(n) of the input. The output z(n) of the absolute value module 520 is input into the threshold module 525 which compares the value of z(n) to a threshold value T. In one implementation, if the value of z(n)>T, the signal detector 218 of the wireless device 202r determines that a received signal r(n) has a sequence of known training fields and the signal detector 218 of the wireless device 202r may determine that a data packet is detected. Further, in such an implementation, if the value of z(n)<T, the signal detector 218 of the wireless device 202r determines that a received signal r(n) does not have a sequence of known training fields and the signal detector 218 of the wireless device 202r may determine that a data packet is not detected. The signal detector 218 may be configured to receive a signal r(n) over time and make determinations as to whether a data packet is detected in a continuous manner as the data passes through the components of the signal detector 218 described above. The value of T may be selected through statistical analysis or by running simulations for a given implementation or system.

In one example, the value of z(n) is an indication of how closely the signal r(n) resembles a sequence of known training fields. Thus, the threshold T may be selected so as to reduce a false alarm rate of the signal detector 218 for detection of packets. In one implementation, the threshold T may be a scaled version of the signal power P (e.g., T=αP). The signal power P may be calculated from the set of samples r(n) that are used in the signal detector 218. By setting the threshold T based on the signal power, a large increase in the noise level of the signal r(n) may not cause a false alarm or increase in the false alarm rate. The value of a may be selected based on the function used to calculate P so as to meet a selected false alarm rate. Further, the value of a may be selected through statistical analysis or by running simulations for a given implementation or system. In one implementation, P may be calculated according to Equation 2 as follows. In Equation 2, L=N×M.

$$P = \frac{1}{L} {\sum }_{n = 1}^{L - 1} r ( n ) {r ( n )}^{*} \qquad ( 2 )$$

As discussed above, in some implementations, there may be a frequency offset between the wireless device 202r and the wireless device 202t. Accordingly, the wireless device 202t may send signals at a first frequency, while the wireless device 202r expects the signals to be sent a second frequency, where the frequency offset is the difference between the first frequency and the second frequency. Such frequency offset may occur due to the oscillators used for operating in the wireless device 202r and 202t having different frequencies. This frequency offset is many times bounded as the wireless devices 202 are manufactured to run at a particular frequency f± some tolerance amount Δf. Accordingly, the wireless device 202t may transmit at a frequency in the range defined by f±Δf.

If there is a frequency offset in the signal r(n) and it is not compensated for, then using a match filter 228 with an impulse response of g(n)=s(−n)* may result in poor performance of the signal detector 218. In particular, the greater the frequency offset without the signal detector 218 being configured to compensate for the frequency offset, the poorer the performance of the signal detector. Accordingly, in some implementations, the signal detector 218 may be configured to compensate for a frequency offset in the signal r(n) as discussed below. For example, the wireless device 202r may comprise a plurality of signal detectors 218, where each signal detector 218 is configured for properly detecting a data packet in a signal with a given frequency offset.

The signal detector 218 may function adequately to detect packets with a small range of frequency offset from the frequency the signal detector 218 is primarily configured to receive signals. Accordingly, if the known range of frequencies the signal r(n) may have is f±Δf, then a plurality K of signal detectors 218, where K is any positive integer, may be used in the wireless device 202r to detect packets. In one implementation, the range f±Δf may be divided into K+1 intervals, with the each of the K signal detectors 218 being configured to primarily received signals at the center frequency of one of the K+1 intervals. For example, if f=0 kHz, Δf=200 kHz, and K=3, there may be 3 signal detectors 218, one configured to primarily receive signals with a frequency offset of 100 kHz, one of 0 kHz, and one of −100 kHz. The K signal detectors 218 of the wireless device 202r are run in parallel, and if any one detects a signal (packet) then the wireless device 202r determines a packet is detected. In order to keep the false alarm rate low, a small increase in T may be made when there are multiple signal detectors 218 (e.g., the increase may be proportional to the value of K). The value of K may be selected through statistical analysis or by running simulations for a given implementation or system.

In one implementation, the signal detector 218 may compensate for a frequency offset as follows and operate to detect signals with difference frequency offsets. The match filter 228 of the signal detector 218 may be configured to have an impulse response g(n)= [symbol] s(−n)*, where fₖ is the frequency offset that the signal detector 218 is configured to receive a signal r(n) with and detect a data packet in the signal. In another implementation, the signal detector 218 may compensate for a frequency offset by multiplying r(n) by [symbol] before inputting r(n) into the match filter 228, where fₖ is the frequency offset that the signal detector 218 is configured to receive a signal r(n) with and detect a data packet in the signal.

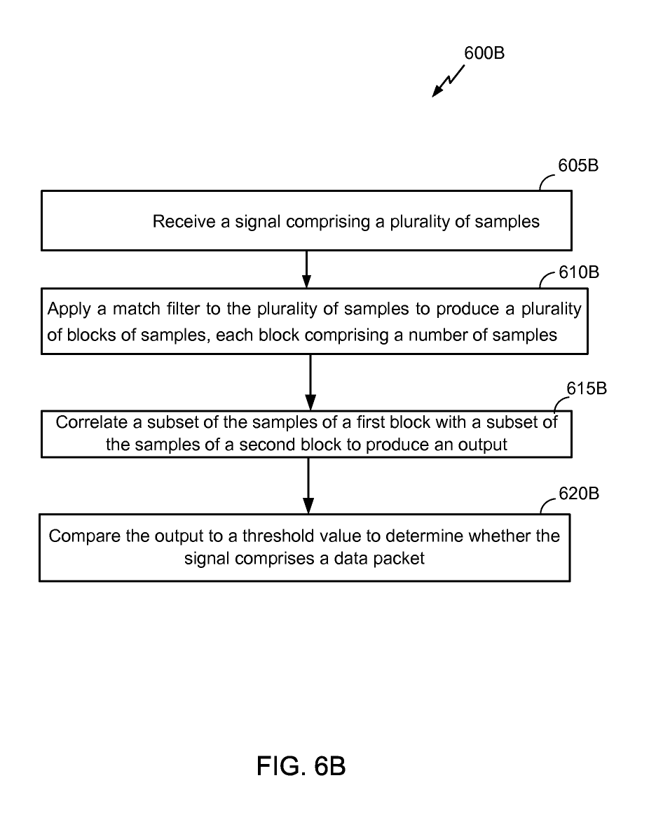

FIG. 6A is a flow diagram illustrating an example packet detection procedure 600 for detecting packets in a signal r(n). At a block 605, the wireless device 202r receives a signal r(n), which may be from a wireless device 202t. Further, at a block 610, the wireless device 202r passes the signal r(n) through a match filter that correlates the signal r(n) with a known training field used by the wireless device 202t to get an output y(n). Further, at a block 615 the first N₀ terms of each block of N terms of the output y(n) are autocorrelated similar to as discussed above, where N₀ is less than N. At a block 620, the results of the autocorrelation are compared to a threshold to determine whether the signal r(n) includes a sequence of known training fields and thus includes a data packet.

FIG. 6B is another flow diagram illustrating an example packet detection procedure 600B for detecting packets, for example, in accordance with implementations described herein. At a block 605B, a wireless device receives a signal, for example, from a wireless device 202t. The signal is sampled and accordingly may comprise a plurality of samples. Further, at a block 610B, the plurality of samples may be passed through a match filter that correlates the signal (e.g., with a known training field used by the wireless device) to get a plurality of output samples from the matched filter processing, and the output samples from the matched filter can be formed into blocks, each block having a plurality of output samples from the matched filter. At a block 615B, a subset of the (matched filter output) samples of a first block may be correlated with a subset of the (matched filter output) samples of a second block to produce an output. At a block 620B, the results of the correlation are compared to a threshold to determine whether the received signal includes a sequence of known training fields and thus includes a data packet.

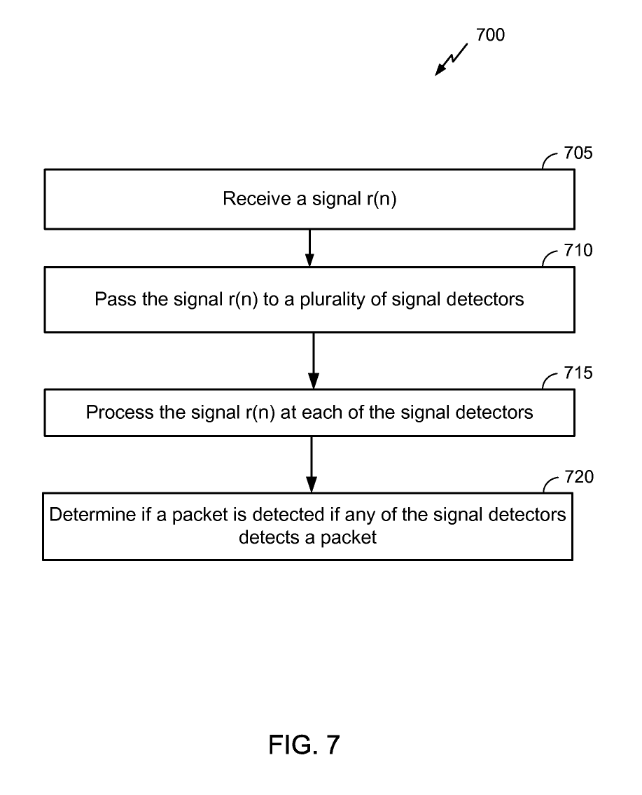

FIG. 7 is a flow diagram illustrating another example packet detection procedure 700 for detecting packets in a signal r(n). At a block 705, the wireless device 202r receives a signal r(n), which may be from a wireless device 202t. At a block 710, the signal r(n) is input into a plurality of signal detectors, each signal detector being configured for primarily process signals of a certain frequency as discussed above. At a block 715, each signal detector processes the input signal r(n) similar to blocks 610-620 of procedure 600 described above to determine whether a packet is detected. At a block 720, it is determined whether a packet is detected based on whether any one of the signal detectors detects a packet.

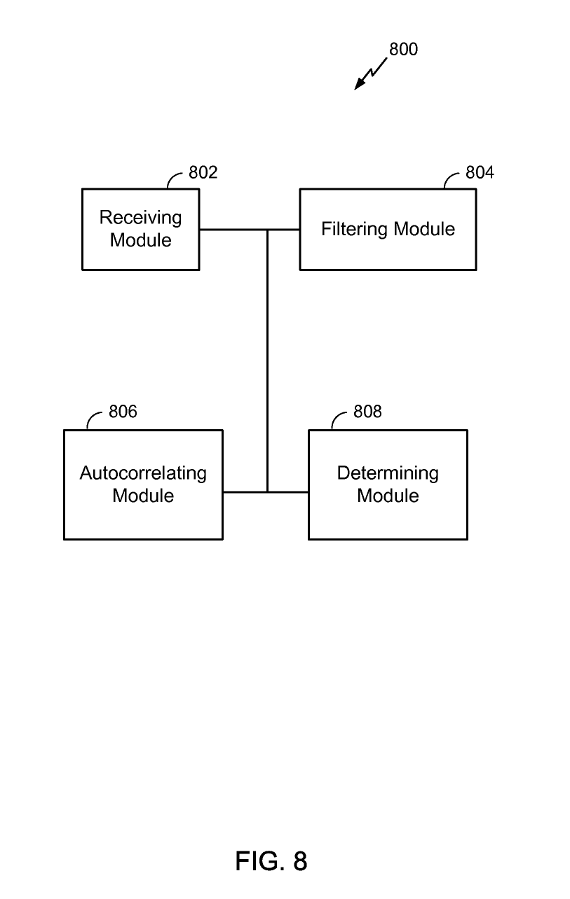

FIG. 8 is a functional block diagram of an exemplary wireless device 800 that may be employed within the wireless communication system 100 of FIG. 1. The device 800 comprises a receiving module 802 for receiving data. The receiving module 802 may be configured to perform one or more of the functions discussed above with respect to the blocks 605 and 705 illustrated in FIGS. 6A, 6B and 7. The receiving module 802 may correspond to one or more of the processor 204, the receiver 212, and the signal detector 218. The device 800 further comprises a filtering module 804 that correlates the received signal with a known training field used by a wireless device 202t to get an output. The filtering module 804 may be configured to perform one or more of the functions discussed above with respect to the blocks 610, 710, and 715 illustrated in FIGS. 6A, 6B and 7. The filtering module 804 may correspond to one or more of the processor 204, the DSP 220, and the match filter 228. The device 800 further comprises an autocorrelating module 806 for autocorrelating the first N₀ terms of each block of N terms of the output, where N₀ is less than N. The autocorrelating module 806 may be configured to perform one or more of the functions discussed above with respect to the blocks 615, 710, and 715 illustrated in FIGS. 6A, 6B and 7. The autocorrelating module 806 may correspond to one or more of the processor 204, the DSP 220, and the autocorrelator 230. The device 800 further comprises a determining module 808 for determining whether a packet is detected. The determining module 808 may be configured to perform one or more of the functions discussed above with respect to the blocks 620 and 720 illustrated in FIGS. 6 and 7. The determining module 808 may correspond to one or more of the processor 204, the DSP 220, and the signal detector 218.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. An apparatus for wireless communication, comprising:
a receiver configured to receive a signal;
circuitry configured to
generate a plurality of samples from the signal;
apply a match filter to a plurality of samples to produce at least a first block of samples and a second block of samples, each block comprising a number of samples,
correlate at least a portion of the samples of the first block and the samples of the second block to produce a correlation output; and
compare the output to a threshold value to determine whether the signal comprises a data packet.

2. The apparatus of claim 1, wherein the received signal comprises a sequence of training fields.

3. The apparatus of claim 1, wherein the match filter is configured such that a response of the match filter is a function of a complex conjugate of a time reversal of a training field.

4. The apparatus of claim 1, wherein the threshold value is determined based on a power level of the received signal.

5. The apparatus of claim 1, wherein the circuitry is further configured to correlate a subset of the samples of a first block with a subset of the samples of a second block to produce the correlation output.

6. The apparatus of claim 1, wherein the circuitry is further configured to:
correlate a subset of the samples of each block of the plurality of blocks with a subset of the samples of a subsequent block of the plurality of blocks to produce a plurality of outputs; and
produce the correlation output from the plurality of outputs.

7. The apparatus of claim 6, wherein the circuitry is further configured to:
sum the plurality of outputs to produce a sum; and
calculate an absolute value of the sum to produce the correlation output.

8. The apparatus of claim 1, wherein a response of the match filter is a function of a complex conjugate of a time reversal of a training field and a frequency offset between a frequency of the signal and an operation frequency of the apparatus.

9. The apparatus of claim 1, wherein the circuitry is further configured to multiply the plurality of samples by a function of a frequency offset between a frequency of the signal and an operation frequency of the apparatus before applying the match filter.

10. The apparatus of claim 1, wherein the circuitry is further configured to:
apply a plurality of match filters to a plurality of copies of the plurality of samples to produce a plurality of different sets of the plurality of blocks of samples;
correlate, for each set of the plurality of blocks, a subset of the samples of each block of the plurality of blocks with a subset of the samples of a subsequent block of the plurality of blocks to produce a plurality of outputs; and
compare each of the plurality of outputs to a threshold value to determine whether the signal comprises a data packet.

11. The apparatus of claim 1, wherein the correlation output is an autocorrelation result.

12. A method for wireless communication, comprising:
receiving a signal comprising a plurality of samples;
applying a match filter to the plurality of samples to produce a plurality of blocks of samples, each block comprising a number of samples;
correlating a subset of the samples of a first block with a subset of the samples of a second block to produce an output; and
comparing the output to a threshold value to determine whether the signal comprises a data packet.

13. The method of claim 12, wherein a response of the match filter is a function of a complex conjugate of a time reversal of a training field.

14. The method of claim 12, wherein the received signal comprises a sequence of training fields.

15. The method of claim 12, wherein the threshold value is determined based on a power level of the signal.

16. The method of claim 12, further comprising:
correlating a subset of the samples of each block of the plurality of blocks with a subset of the samples of a subsequent block of the plurality of blocks to produce a plurality of outputs; and
producing the correlation output from the plurality of outputs.

17. The method of claim 16, wherein producing the correlation output comprises:
summing the plurality of outputs to produce a sum; and
calculating an absolute value of the sum to produce the correlation output.

18. The method of claim 12, wherein a response of the match filter is a function of a complex conjugate of a time reversal of a training field and a frequency offset between a frequency of the signal and an operation frequency of a receiver that receives the signal.

19. The method of claim 12, further comprising multiplying the plurality of samples by a function of a frequency offset between a frequency of the signal and an operation frequency of a receiver that receives the signal before applying the match filter.

20. The method of claim 12, further comprising:
applying a plurality of match filters to a plurality of copies of the plurality of samples to produce a plurality of different sets of the plurality of blocks of samples;
correlating, for each set of the plurality of blocks, a subset of the samples of each block of the plurality of blocks with a subset of the samples of a subsequent block of the plurality of blocks to produce a plurality of outputs; and
comparing each of the plurality of outputs to a threshold value to determine whether the signal comprises a data packet.

21. An apparatus for wireless communication, comprising:
means for receiving a signal comprising a plurality of samples;
means for filtering the plurality of samples to produce a plurality of blocks of output samples, each block comprising a number of match filter output samples;
means for correlating a subset of the samples of a first block with a subset of the samples of a second block to produce an output; and
means for comparing the output to a threshold value to determine whether the signal comprises a data packet.

22. The apparatus of claim 21, wherein the signal receiving means comprises a receiver.

23. The apparatus of claim 21, wherein the filtering means comprises a matched filter.

24. The apparatus of claim 21, wherein the correlating means comprises a correlators circuit.

25. The apparatus of claim 21, wherein the comparing means comprises a processor.

26. An apparatus for wireless communication, comprising:
a receiver configured to receive a signal comprising a plurality of samples; and
circuitry configured to
apply a match filter to the plurality of samples to produce a plurality of blocks of match filter output samples, each block comprising a number of match filter output samples,
generate at least one autocorrelation result from the plurality of blocks of the match filter output samples, and
compare the autocorrelation result to a threshold value to determine whether the signal comprises a data packet.

27. The apparatus of claim 26, wherein the match filter is configured such that an impulse response of the match filter is a function of a complex conjugate of a time reversal of a training field.

28. The apparatus of claim 26, wherein the received signal comprises a sequence of training fields.

29. The apparatus of claim 26, wherein the threshold value is determined based on a power level of the received signal.

30. A computer readable medium comprising instructions that when executed cause an apparatus to:
receive a signal comprising a plurality of samples;
apply a match filter to the plurality of samples to produce a plurality of blocks of samples, each block comprising a number of samples;
correlate a subset of the samples of a first block with a subset of the samples of a second block to produce an output; and
compare the output to a threshold value to determine whether the signal comprises a data packet.

31. The apparatus of claim 30, wherein the threshold value is determined based on a power level of the received signal.
